(19) United States
(12) Patent Application Publication
(10) Pub. No.: US 2024/0305813 A1
(43) Pub. Date: Sep. 12, 2024

(54) METHODS AND APPARATUS FOR SUB-PICTURE ADAPTIVE RESOLUTION CHANGE

(71) Applicant: VID SCALE, INC., Wilmington, DE (US)

(72) Inventors: Yong He, San Diego, CA (US); Ralph Neff, San Diego, CA (US); Yuwen He, San Diego, CA (US)

(21) Appl. No.: 18/666,189

(22) Filed: May 16, 2024

Related U.S. Application Data
(63) Continuation of application No. 17/438,300, filed on Sep. 10, 2021.
(60) Provisional application No. 62/816,686, filed on Mar. 11, 2019.
(60) Provisional application No. 62/866,528, filed on Jun. 25, 2019.

(51) Int. Cl. H04N 19/59; H04N 19/172; H04N 19/33; H04N 19/70

(52) U.S. Cl. CPC H04N 19/59; H04N 19/172; H04N 19/33; H04N 19/70

(57) ABSTRACT

Methods and apparatus relate to picture and video coding in communication systems are provided. Included therein is a method comprising determining one or more layers associated with a parameter set, generating a syntax element including an indication indicating whether the one or more layers associated with the parameter set are independently coded, and generating a message including the syntax element.

### CROSS-REFERENCE TO RELATED APPLICATIONS

This application claims priority to and the benefit of U.S. Provisional Application No. 62/816,686 filed in the U.S. Patent and Trademark Office on Mar. 11, 2019, and U.S. Provisional Application No. 62/866,528 filed in the U.S. Patent and Trademark Office on Jun. 25, 2019, the entire contents of each of which being incorporated herein by reference as if fully set forth below in their entirety and for all applicable purposes.

### SUMMARY

Embodiments disclosed herein generally relate to methods and apparatus for picture and/or video coding in communication systems.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is block diagram illustrating an example of a video streaming architecture, according to one or more embodiments;

FIG. 3 illustrates an example of an adaptive resolution change (ARC), according to one or more embodiments;

FIG. 4 illustrates an example of viewport adaptive streaming, according to one or more embodiments;

FIG. 5 illustrates an example of viewport switching, according to one or more embodiments;

FIG. 6 illustrates an example of a viewport switching with ARC, according to one or more embodiments;

FIG. 7 illustrates an example of ARC carried out based on sub-picture property information provided by a supplemental enhancement information (SEI) message, according to one or more embodiments;

FIG. 8 illustrates an example of an ARC transition between low-resolution representation and high-resolution representation, according to one or more embodiments;

FIG. 9 illustrates an example encoding procedure to determine one or more ARC transition points, according to one or more embodiments; and

FIG. 10 illustrates an example of ARC based on inter-layer prediction, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

### Representative Communications Network

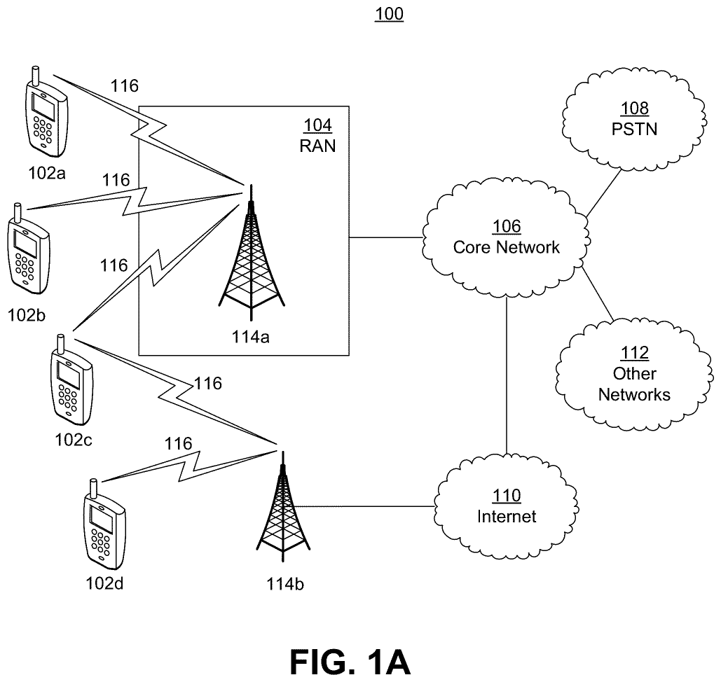

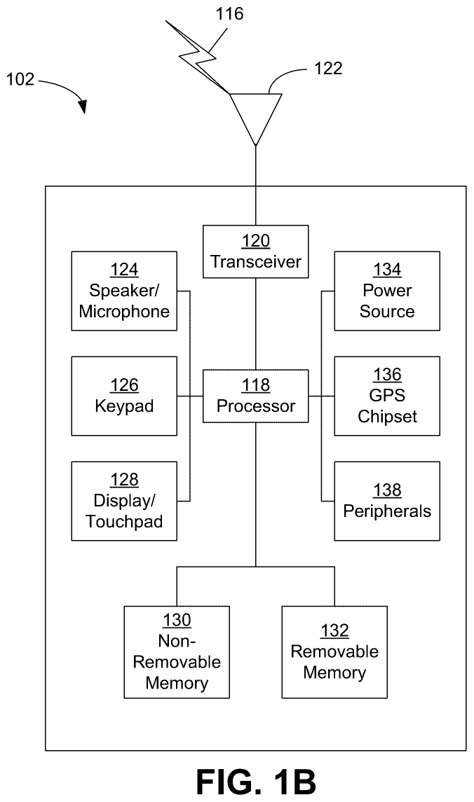

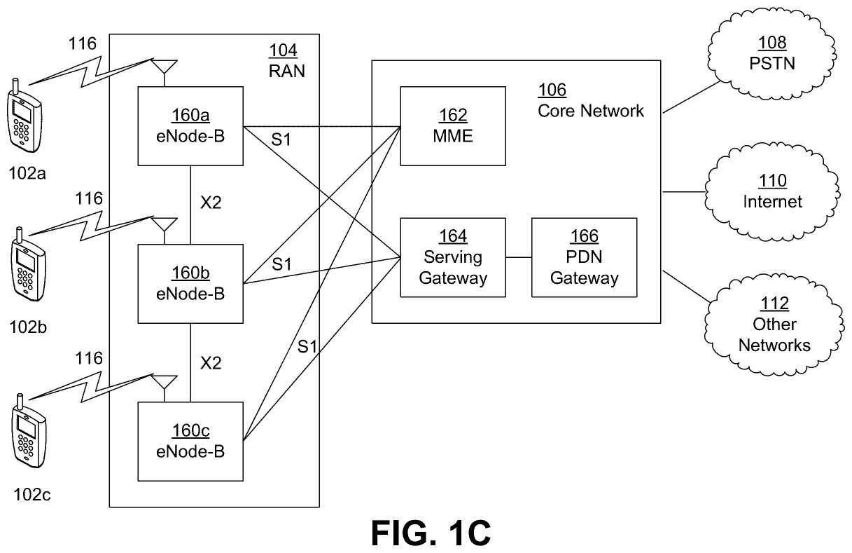

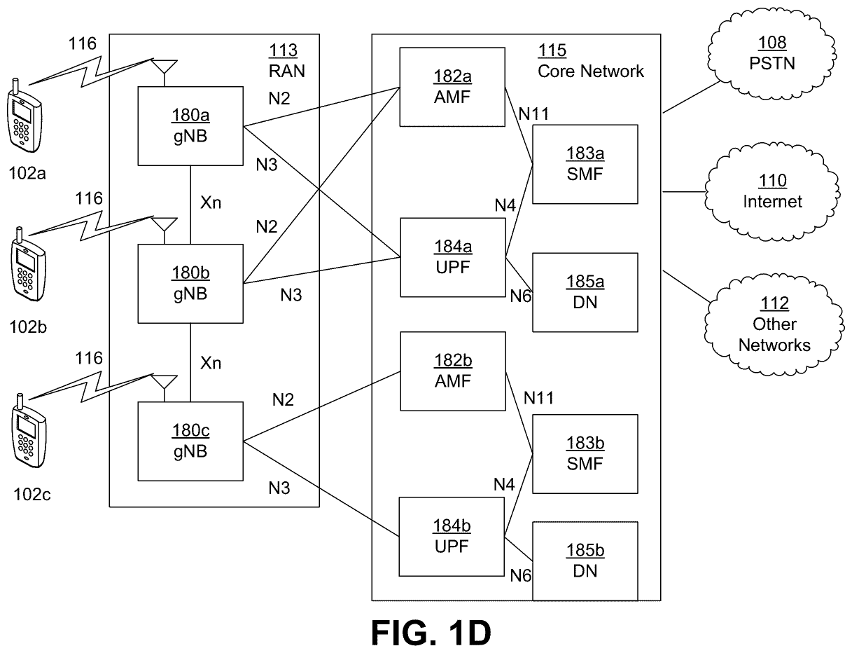

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a New Radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, a Home Node B, a Home eNode B, or an access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In some representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating a WTRU or UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Representative Architectures/Frameworks

Video coding systems may be used to compress digital video signals, which may reduce the storage needs and/or the transmission bandwidth of video signals. Video coding systems may include block-based, wavelet-based, and/or object-based systems. Block-based video coding systems may be based on, use, be in accordance with, comply with, etc. one or more standards, such as MPEG-1/2/4 part 2, H.264/MPEG-4 part 10 AVC, VC-1, High Efficiency Video Coding (HEVC) and/or Versatile Video Coding (VVC). Block-based video coding systems may include a block-based hybrid video coding framework.

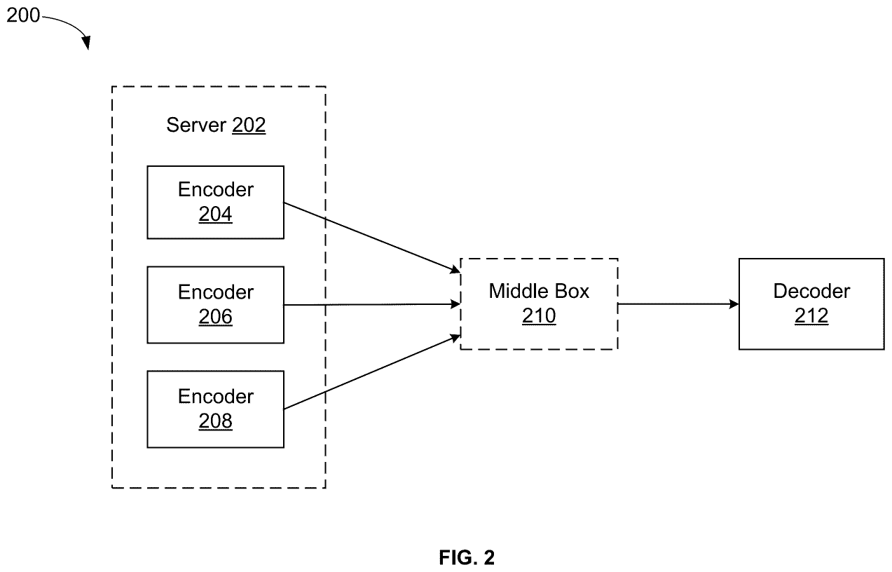

FIG. 2 is block diagram illustrating an example of a video streaming architecture 200. In this example, a server 202 may consist one or multiple video encoders (e.g., encoders 204, 206, and 208), each encoder may generate a video bitstream at different resolution, frame rate, or bitrate. A middle box 210 may be used or configured. In an example, the middle box 210 may be a media aware network element (MANE). The middle box 210 may generate, forward, identify, or parse a high-level syntax of input video bitstream(s), extract a sub-bitstream from one input video bitstream, and/or output the extracted sub-bitstream to the client or decoder 212. The middle box 210 may extract multiple sub-bitstreams from multiple input video bitstreams and combine them together to form a new output video bitstream delivering to the client or decoder 212.

In various embodiments, one or more encoders (e.g., encoders 204, 206, and/or 208), the middle box 210, and/or the decoder 212 may be implemented in a device having a processor communicatively coupled with memory. The memory may include instructions executable by the processor, including instructions for carrying out any of various embodiments (e.g., representative procedures) disclosed herein. In various embodiments, the device may be configured as and/or configured with various elements of a wireless transmit and receive unit (WTRU). Example details of WTRUs and elements thereof are provided herein in FIGS. 1A-1D and accompanying disclosure.

Various methods and aspects described in this application can be used to modify modules, for example, the intra prediction, entropy coding, and/or decoding modules of one or multiple video encoders (e.g., encoders 204, 206, and 208) and decoder 212 as shown in FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

### Representative Procedure for Adaptive Procedure for Resolution Change

Various schemes using AVC and/or HEVC may not have the ability to change resolution(s) without introducing an intra random access point (IRAP) picture. An IRAP picture coded at a reasonable quality generally has a much larger frame size (e.g., a larger number of bits used to code the frame) than a non-IRAP picture. Additionally, an IRAP picture is more complex to decode. Adaptive resolution change (ARC) may refer to any of a scheme and capability where spatial resolution may change at a non-IRAP picture.

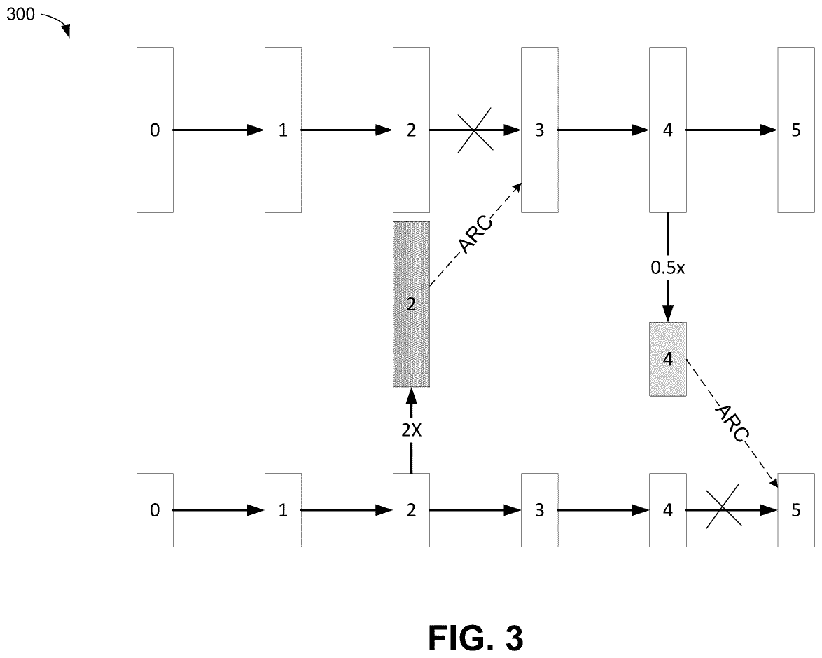

FIG. 3 illustrates an example of ARC mechanism 300. With reference to FIG. 3, a high-resolution picture frame No. 3 may be encoded with inter-prediction from a reference picture frame No. 2 having a same resolution and a low-resolution picture frame No. 5 may be encoded with inter-prediction from a reference picture frame No. 4 having a same resolution. During ARC, the high-resolution picture frame No. 3 may be reconstructed by the reference picture frame No. 2 that is upscaled from a low-resolution picture frame No. 2 for motion compensation, and the low-resolution picture frame No. 5 may be reconstructed by the reference picture frame No. 4 that is downscaled from a high-resolution picture frame No. 4 for motion compensation. As a result, resolution switching(s) may happen or be performed on one or more non-IRAP frames.

In various implementations, for example, multi-party video conferencing may benefit from using ARC to process picture and/or video (“picture/video”) frames, where one or more, or all participants (i.e., pictures/videos thereof) are displayed individually on a shared screen, and an active speaker (i.e., picture/video thereof) is displayed in a larger video size than the rest of the participants. If the active speaker changes frequently, ARC may be used (e.g., be required to be used) to efficiently achieve frequent and/or unpredictable resolution changes due to swapping in a new active speaker and swapping out the old one. Current adaptive video streaming approaches usually change video representation bitrate or resolution after an IRAP picture to match the varying network bandwidth.

ARC may improve adaptive streaming performance by obviating the need to send one or more high (or large) frame-size IRAP pictures. ARC may reduce streaming start latency as the application usually buffers up to a certain number of decoded pictures and/or range of decoding time before displaying and, for example, in view of smaller sized pictures. Under current motion-constrained tile set (MCTS)-based viewport adaptive 360-degree video streaming, sub-pictures that represent a viewport are usually delivered using a high resolution, and sub-pictures that represent other areas (e.g., areas not in the user's view) are usually delivered using a lower resolution. When the viewport changes, the corresponding resolutions of the sub-pictures are changed accordingly, and user experience is affected by switching latency of the high-quality viewport.

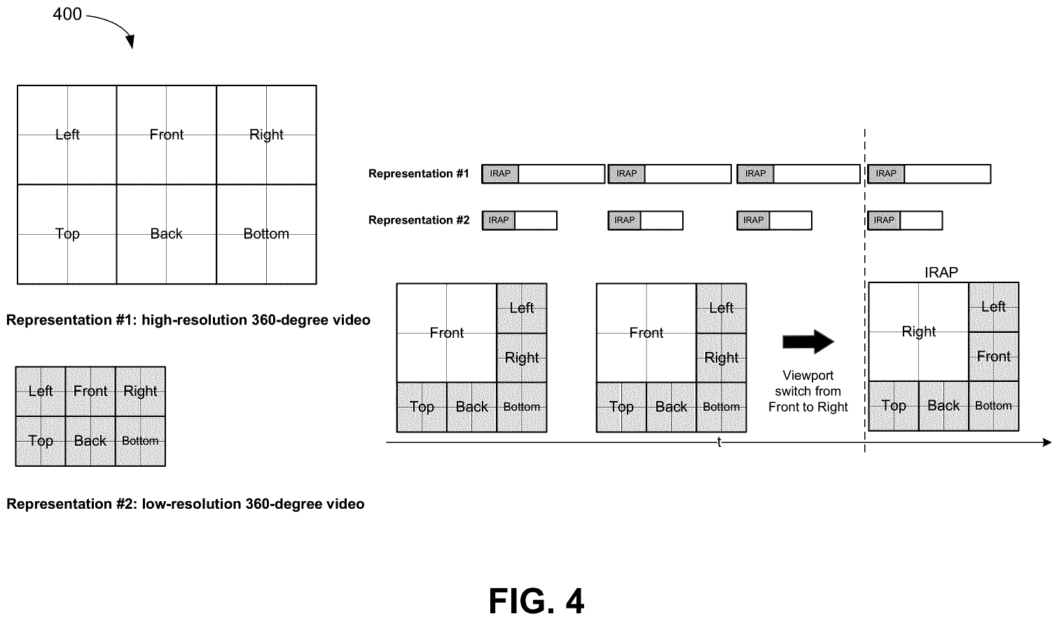

FIG. 4 illustrates an example of viewport adaptive streaming mechanism 400. A viewport sub-picture (e.g., front view) is extracted from a large-resolution 360-degree video (Representation No. 1) and sub-pictures that represent other areas are extracted from a low-resolution 360-degree video (Representation No. 2). The extracted sub-pictures may be combined into a single representation, (e.g., as illustrated by a series of frames at the bottom right of FIG. 4). The resulting composed or merged viewport adaptive video is delivered to the user (or client) so that the user can experience a high-quality viewport with reduced delivery bandwidth. In case the user changes the viewport from front view to right view, the high-resolution right view sub-picture is extracted upon an IRAP picture, and a new video frame of the composed or merged video is formed that incorporates the high-resolution right view sub-picture and the low-resolution front sub-picture. As a result, the length of IRAP distance may affect the high-quality viewport switching latency, and a high-bitrate IRAP picture may also increase the network and/or processing load. ARC may enable faster viewport switching and may support different IRAP distances for different (e.g., 360-degree) video representations.

Picture/video frames may be predicted across resolutions by re-scaling reference pictures (e.g., using approach(es) proposed in [1] and/or [2]). A picture resolution index (PRI) may be signaled in a picture parameter set (PPS) to indicate that a slice (e.g., associated with a picture) is from the picture and has a resolution indicated by the index. It may be desirable to allow merging of a sub-picture originating from a random-access (e.g., IRAP) picture and another sub-picture originating from a non-random-access (e.g., non-IRAP) picture into the same coded picture conforming to as Versatile Video Coding (VVC) (e.g., using the scheme proposed in [3]).

### Representative Procedure for Viewport Switching

For viewport adaptive streaming (e.g., in connection with 360-degree video), a sub-bitstream corresponding to each sub-picture may be extracted from its original bitstream and/or representation, and multiple sub-bitstreams may be merged to form a new bitstream. The original and/or new bitstreams may be, for example, HEVC, VVC and/or like-type bitstreams. In current viewport adaptive streaming, sub-bitstream merging is carried out in the compressed domain, and doing so can introduce several issues. For example, viewport switching happens only when all involved sub-pictures are instantaneous decoding refresh (IDR) pictures to ensure non-IRAP pictures that follow (in time) have correct reference pictures and/or reference sub-pictures. Use of IDR pictures, however, may introduce latency issues.

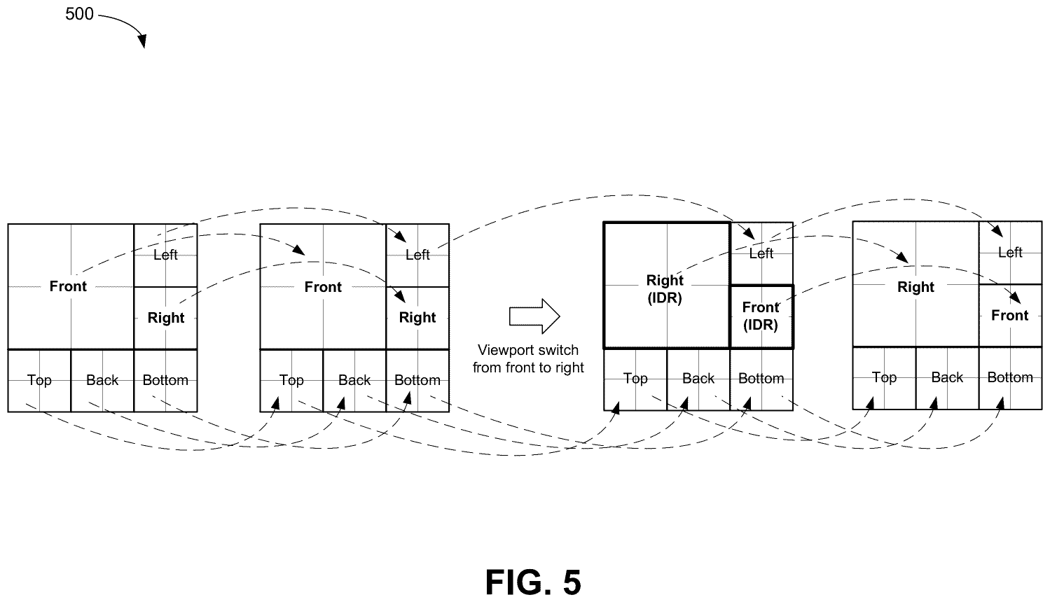

FIG. 5 illustrates a viewport switching mechanism 500 in which a current viewport is switched to new viewport. With reference to FIG. 5, a right view sub-picture undergoes switching from a lower resolution to a higher resolution, and a front view sub-picture undergoes switching from a higher resolution to a lower resolution, to match the new viewport. Dash lines represent temporal inter-prediction. In current viewport switching schemes, the switching may only happen when both right view sub-picture at a higher resolution and front view sub-picture at a lower resolution are IDR pictures as the following sub-pictures of the same view are inter-predicted from the same resolution sub-pictures. The other sub-pictures, such as top, back, left and bottom views do not have to be encoded as IRAP pictures as the inter-prediction is continued on the sub-pictures having the same resolution.

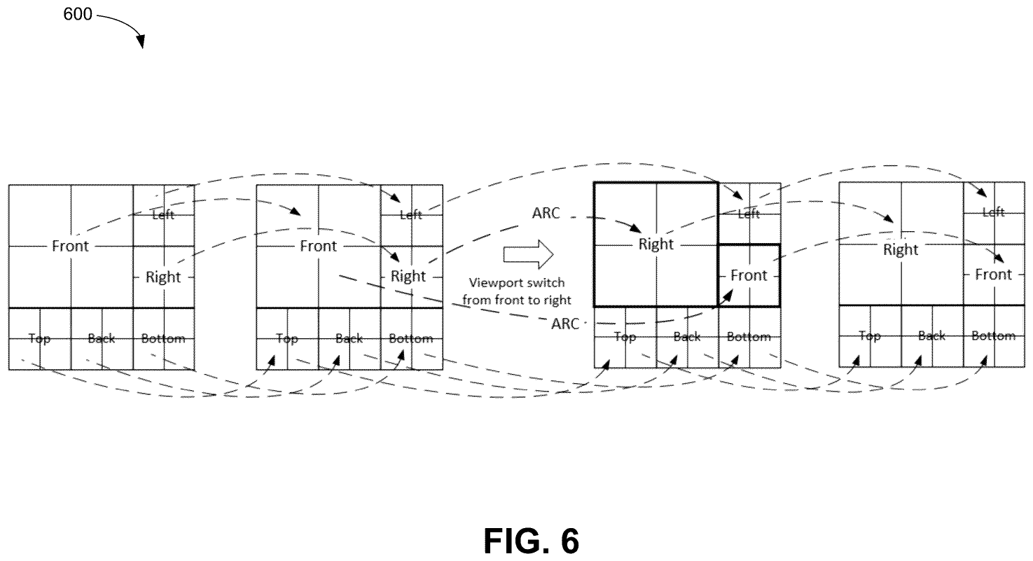

Pursuant to the methodologies and/or technologies provided herein, ARC may be carried out in connection with adaptive viewpoint switching (and/or adaptive viewport streaming) so that, for example, sub-pictures may be predicted from sub-pictures of the same view at different resolution. FIG. 6 illustrates an example of a viewport switching mechanism 600 with ARC. With reference to FIG. 6, a high-resolution right view sub-picture may be predicted from a previous low-resolution right view sub-picture, and a low-resolution front view sub-picture may be predicted from a previous high-resolution front view sub-picture. By using previous sub-pictures, the sub-pictures to be predicted may be predicted without introducing IRAP sub-pictures. Both switching latency and transport bitrate may be reduced by not introducing IRAP sub-pictures.

Currently, VVC does not specify the decoding process for such sub-picture extraction and repositioning scheme, including when the same view sub-picture may be packed at a different position (e.g., a position which changes at certain times) within the picture. A motion vector of each sub-picture may provide an offset from coordinate(s) in the decoded sub-picture to coordinate(s) in a reference sub-picture, and the coordinates shall be (or at least may be assumed to be) consistent across pictures with the same resolution.

Still referring to FIG. 6, the reference sub-picture may be scaled up or scaled down to match the resolution of a current sub-picture, but the coordinate of the reference sub-picture and current sub-picture within the picture may be different. Pursuant to the methodologies and/or technologies provided herein, current decoding process and associated signaling may be modified to achieve and/or implement the viewport adaptive approach disclosed herein. The methodologies and/or technologies provided herein address deficiencies in current signaling associated with the decoding, including the deficiency that there is no signaling or metadata to identify the set or group of sub-pictures of multiple representations mapping to the same two-dimensional (2D) or three-dimensional (3D) content region, for example, at elementary bitstream level or system level.

Several supplemental enhancement information (SEI) messages specify the rectangular region and 360-degree video information in HEVC. A pan-scan rectangular SEI message specifies the coordinates of one or more rectangular areas relative to the conformance cropping window specified by the active SPS. An equirectangular and cube-map projection SEI messages provides information to enable remapping of the color samples of the projected pictures onto a sphere coordinate space (e.g., addressed using spherical coordinates) to support 360-degree video pictures. A region-wise packing SEI message provides information to enable remapping of the color samples of the cropped decoded pictures onto projected pictures as well as information on the location and size of the guard bands, if any. However, all these SEI messages are designed for a single representation (or layer) and so do not address the relationships between sub-pictures across multiple representations with different resolutions.

### Representative Procedure for Sub-Picture Based Applications

For some sub-picture based applications, each extracted sub-picture may be assigned to a different position in a new picture. As used herein, a sub-picture property SEI message refers to a SEI message including sub-picture property information that may indicate (and/or define properties or indicated defined properties of) one or more sub-pictures or tile groups across multiple layers or representations associated with the same source content region. In an embodiment, the sub-picture property information may include one or more additional indicators to indicate one or more recommended ARC switching points. Alternatively, the sub-picture property SEI message or like-type SEI message may include the indicators to indicate one or more recommended ARC switching points. In an embodiment, the sub-picture property information may include one or more actual ARC switching points, e.g., to achieve better reconstructed picture quality or apply certain constraints. Alternatively, the sub-picture property SEI message or like-type SEI message may include the one or more actual ARC switching points.

### Sub-Picture Property SEI Message

In an embodiment, a video content may be encoded into multiple coded versions or representations (or layers). Each representation may be coded in different resolutions and/or quality. For 360-degree video, for example, each representation may be in different projection and/or region-wise packing formats. The original content region may map to different portions of the representation, namely, sub-pictures. A sub-picture may be rotated, scaled or projected differently in different representations. The position and size of the sub-picture corresponding to the same content region may vary across different representations as well. A middlebox or client may fetch one or multiple sub-pictures across the representations. The middlebox or client may form a new picture for viewport dependent streaming applications using the multiple fetched sub-pictures. The new picture may combine different sub-pictures at different quality levels and/or resolutions. The new picture formation may be carried out, for example, to meet a streaming need of a (e.g., 360-degree) video client.

In an embodiment, a content producer may generate multiple representations. All representations associated with the same content may be configured into a multi-layer structure. In an embodiment, each representation may be a layer. Each layer may be independently coded or may depend on other layers. A layer ID may be used to identify the specific coded video representation. Each layer may have multiple sub-pictures. Each sub-picture may be identified by a unique sub-picture ID or tile group ID. It might be possible to derive the correspondence between the sub-picture and the original content region (e.g., a region on the 360-degree content sphere) from projection and region-wise packing SEI messages associated with each representation. Doing so, however, would require the middlebox or client to parse multiple SEI messages from each layer and the derivation process may increase the workload of middlebox or client. A single SEI message or parameter set describing the sub-picture properties (e.g., the correspondence between subpictures across multiple layers, and the mapping of subpictures in each layer to regions on the (e.g., 360-degree) video sphere) may simplify the mapping between the sub-picture and the corresponding original content region to facilitate sub-picture based applications.

In an embodiment, a sub-picture partitioning layout may be signaled in a PPS. The sub-picture resolution may be signaled explicitly (e.g., in a PPS or a tile group header). Alternatively, sub-picture resolution may be derived from the tile group layout and the entire picture resolution. In order to map a (e.g., each) sub-picture to the corresponding sphere space, the sub-picture property SEI message may include and/or provide information such as layer ID, tile group ID, the coordinate of sub-picture and its mapping onto a sphere coordinate space. The SEI message may list any or all sub-pictures available for viewport adaptive streaming and the region-wise packing of the sub-pictures. The decoder may identify the corresponding reference sub-picture which may or may not collocate with the current sub-picture based on such SEI message. Depending on the resolution of the reference sub-picture, the decoder may scale the sub-picture for ARC and align the coordinate between the current sub-picture and the reference sub-picture.

Table 1 provides an example of a sub-picture property SEI message syntax structure. Table 1 lists the number of sphere regions (viewports) and the sub-pictures covering the same sphere region. Table 1 also provides the coordinates of each repositioned sub-picture relative to the conformance cropping window specified by an active Sequence Parameter Set (SPS).

TABLE 1
An example of a sub-picture property SEI message

| | Descriptor |
|---|---|
| sub_picture_property( payloadSize ) { | |
| num_source_content_regions_minus1 | ue(v) |
| for( i = 0; i <= num_source_content_regions_minus1; i++ ) { | |
| source_content_region_position[ i ] | |
| source_content_region_size[ i ] | |
| num_subpics_minus1 | ue(v) |
| for( j = 0; j <= num_subpics_minus1; j++ ) { | |
| layer_id[ i ][ j ] | u(16) |
| subpic_id[ i ][ j ] | u(16) |
| subpic_coordinate[ i ][ j ] | |
| subpic_width[ i ][ j ] | u(16) |
| subpic_height[ i ][ j ] | u(16) |
| } | |
| } | |
| } | |

In Table 1, num_source_content_regions_minus1 plus 1 may specify the number of source content region that are specified by the SEI message.

In Table 1, source_content_region_position may specify the position of i-th source content region. For 2D source content, it may be the region's top-left position in 2D coordinate. For 360-degree video content, it may be the sphere center azimuth and tilt position.

In Table 1, source_content_region_size may specify the size of i-th source content region. For 2D source content, it may be the region's width and height. For 360-degree video content, it may be the tilt angle relative to the global coordinate axes, azimuth range and elevation range of the sphere region through the center point of the sphere range in degrees.

In Table 1, num_subpics_minus1[i] plus 1 may specify the number of sub-pictures associated with the i-th source content region.

In Table 1, layer_id[i][j] may specify the layer identifier that j-th sub-picture associated with i-th source content region belongs to.

In Table 1, subpic_coordinate[i][j] may specify the coordinate of j-th sub-picture associated with i-th source content region within a picture. It could be the top-left position of the sub-picture or the center position of the sub-picture.

In Table 1, subpic_id[i][j] may specify the sub-picture ID of j-th sub-picture associated with i-th source content region. The sub-picture ID and/or tile group ID may be used to identify sub-picture.

In Table 1, subpic_width[i][j] and subpic_height[i][j] may specify the resolution of j-th sub-picture associated with i-th source content region.

In various embodiments, the properties such as bit depth, color subsampling, encoding profile and/or encoding level for each sub-picture or group of sub-pictures may be included in a sub-picture property SEI message.

In various embodiments, sub-picture property SEI message may indicate the number of sub-pictures associated with the same source content region among multiple representations or layers. The decoder may determine the corresponding reference sub-picture available in the previous pictures and derive the reference sub-picture position and size from the active PPS to carry out ARC. The disclosed SEI message may explicitly signal the position and size of each sub-picture, e.g., to simplify the derivation so that the decoder does not have to parse parameter sets or SEI messages of each representation or layer. The disclosed syntax elements of sub-picture property SEI message may also be carried by cross-layer parameter set such as video parameter set (VPS) or decoder parameter set (DPS).

In various embodiments, the middlebox may rely on the disclosed SEI message. For example, the middlebox may extract sub-pictures matching the viewport based on the SEI message. The middlebox may form an ARC picture using the extracted sub-pictures, e.g., to reduce the frame size (e.g., the number of bits required to code the frame). The client may rely on the proposed SEI message. For example, the client may identify the ARC sub-picture and the associated reference sub-pictures based on the SEI message. The client may align the coordinate(s) between ARC sub-picture and reference sub-picture for proper motion compensation process.

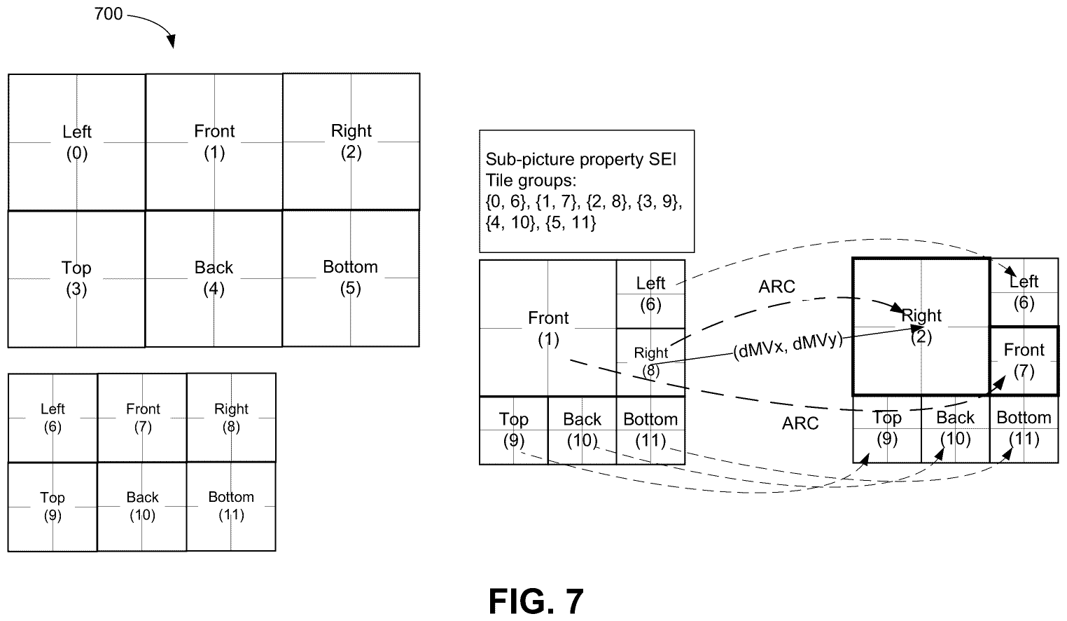

FIG. 7 illustrates an example of sub-picture based ARC mechanism 700. With reference to FIG. 7, each sub-picture of cube-map projection format may be coded into two resolutions. A sub-picture matching the viewport may be extracted from the high-resolution representation. The rest of the sub-pictures may be extracted from the low-resolution representation. In various embodiments, a sub-picture property SEI message may indicate those sub-pictures associated with the same source content region. For example, both tile group No. 0 and tile group No. 6 cover the left face, and both tile group No. 1 and tile group No. 7 cover the front face but at different resolutions and in different representations.

In case the extractor extracts a non-IRAP high-resolution sub-picture to match the viewport change, the extractor may signal the ARC occurrence with the sub-picture property SEI message. The decoder may figure out both Right and Front sub-pictures are ARC sub-pictures as sub-picture No. 2 (Right) and No. 7 (Front) are not available in the previous pictures. To reconstruct the ARC sub-picture, the decoder may parse the SEI message and may identify those sub-pictures associated with the same region as tile group No. 2 and tile group No. 7. For instance, tile group No. 1 may be associated with the same content region as tile group No. 7 and may be available in a previously decoded picture. Tile group No. 8 may be associated with the same content region as tile group No. 2 and may be available in a previously decoded picture. Based on the sub-picture position and size derived from PPS, the decoder may scale down decoded sub-picture No. 1 and scale up decoded sub-picture No. 8 for ARC motion compensation. The motion vector of each sample of sub-picture No. 2 may (e.g., shall) shift by the offset between the coordinate of sub-picture No. 2 and the coordinate of sub-picture No. 8, e.g., as marked (dMVx, dMVy) in FIG. 7. The offset may be in units of one-sixteenth sample spacing relative to the luma sampling grid, for example. The same motion vector shift may also apply to each sample of tile group No. 7.

In an embodiment, all sub-pictures associated with the same source content region may be assigned to a sub-picture group, each sub-picture group may have its own unique ID. The sub-picture group ID and its property such as the region position and size may be carried in a tile group header, or in PPS tile group layout syntax field.

In an embodiment, SEI property message may signal the property of current sub-picture and its associated reference sub-picture during ARC, including identifier, coordinate, sub-picture size, bit depth, chroma subsampling, projection format, region-wise packing, etc. Table 2 provides an example of an ARC sub-picture property SEI message.

TABLE 2
An example of an ARC sub-picture property SEI message

| | Descriptor |
|---|---|
| arc_sub_picture_property( payloadSize ) { | |
| num_arc_subpics_minus1 | ue(v) |
| for( i = 0; i <= num_arc_subpics_minus1; i++ ) { | |
| arc_subpic_id[ i ] | ue(v) |
| arc_subpic_coordinate[ i ] | |
| arc_subpic_size[ i ] | ue(v) |
| reference_subpic_id[ i ] | ue(v) |
| reference_subpic_coordinate[ i ] | |
| reference_subpic_size[ i ] | ue(v) |
| } | |
| } | |

In Table 2, num_arc_subpics_minus1 plus 1 may specify the number of sub-pictures associated with adaptive resolution change.

In Table 2, arc_subpic_id[i] and arc_subpic_id[i] may specify the identifier of i-th ARC sub-picture and associated reference sub-picture.

In Table 2, arc_subpic_coordinate[i] and arc_subpic_size[i] may specify the coordinate (e.g. the center or top-left sample position) and size of i-th ARC sub-picture.

In Table 2, reference_subpic_coordinate[i] and reference_subpic_size[i] may specify the coordinate (e.g. the center or top-left sample position) and size of reference sub-picture of i-th ARC sub-picture.

In various embodiments, an ARC sub-picture SEI message may include information indicating the format of ARC sub-picture and the associated reference sub-picture, including bit depth, color subsampling, encoding profile and/or encoding level.

In various embodiments, an ARC sub-picture SEI message may include information indicating the coding sub-picture(s) after ARC and the corresponding reference sub-picture(s) before ARC. The client can scale or transform (e.g., mirror, scale or rotate) the corresponding reference picture for motion compensation based on such indication(s). The message may be (e.g., usually) generated by the middlebox or extractor that extracts and repositions the sub-picture bitstreams. The message may (e.g., shall) attach to the ARC picture. Base on such message, the client or decoder may identify the ARC sub-picture and the associated reference sub-picture and align coordinate between two sub-pictures for motion compensation.

### Recommended ARC Transition SEI Message

In various embodiments, ARC may use a scaled reconstructed picture as reference picture, e.g., to avoid high-bitrate IDR or IRAP picture and/or to maintain acceptable decoding picture quality. There may be multiple versions of encoded video of the same content. The ARC transition performance including the reconstructed picture quality and error propagation may depend on the scale filter design, the reference picture and the temporal layer.

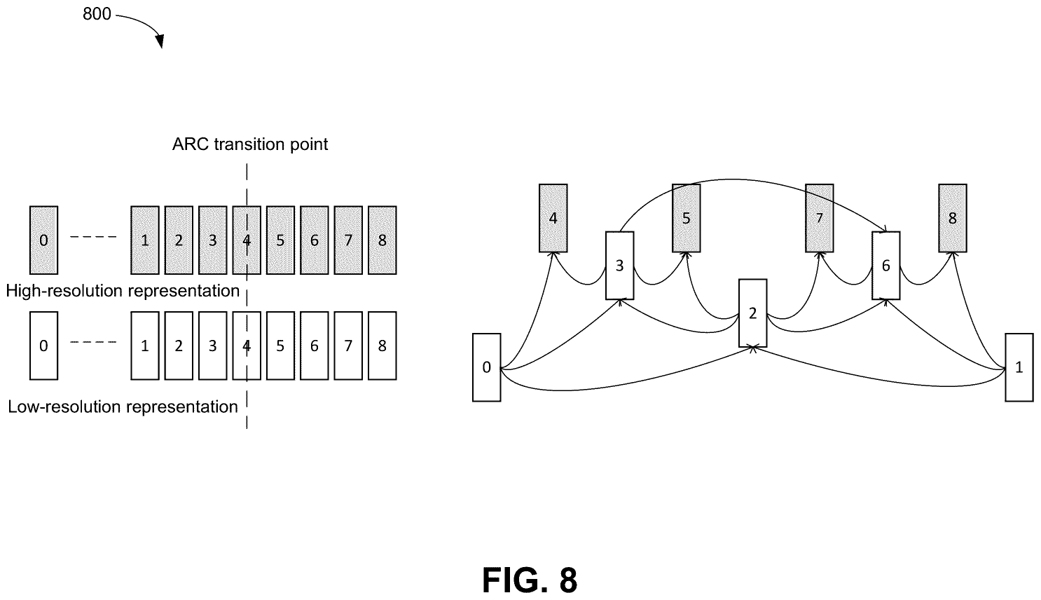

FIG. 8 illustrates a temporal scalability mechanism 800, where ARC transition on POC No. 4 might not cause error propagation. Depending on the sub-picture's correlation among different version and the coding structure, the encoder may be aware of the best ARC transition point. For example, the encoder may simulate ARC within each IRAP interval or group of pictures (GOP) interval to determine the transition point for ARC.

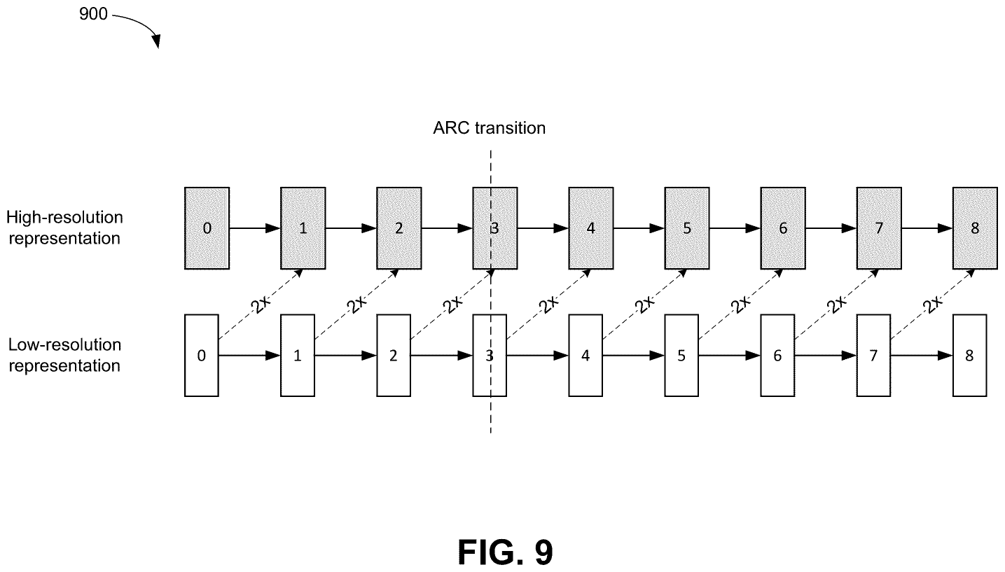

FIG. 9 illustrates an example to determine the optimal ARC transition point. Besides conventional temporal inter-prediction and motion compensation, the encoder may simulate reconstructing the picture by referencing the scaled picture from different representations and calculate PSNR, and mark the picture achieving highest peak signal-to-noise ratio (PSNR) as the recommended ARC transition point.

In an embodiment, to determine the ARC transition point (e.g., POC No. 3), a mechanism 900 may carry out inter-layer prediction as specified in SHVC periodically between two representations. The additional inter-layer coding data may be delivered to the end user when ARC is carried out.

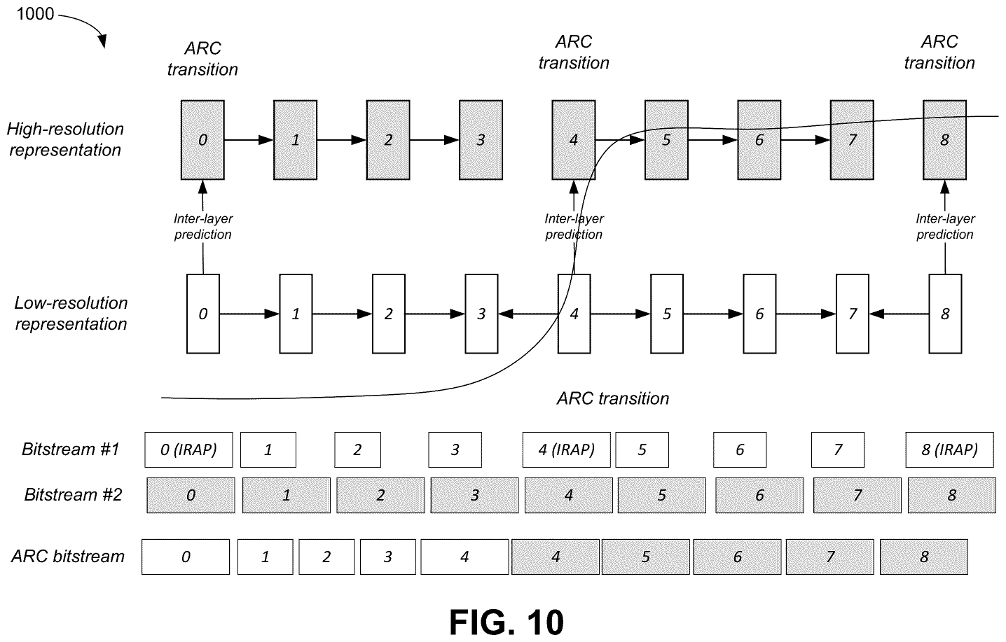

FIG. 10 shows an exemplary mechanism 1000 where high-resolution representation picture is predicted from scaled low-resolution IRAP picture periodically. These pictures are marked as ARC transition pictures. The transition from low-resolution to high-resolution representation may only occur at these ARC transition points, while the transition from high-resolution to low-resolution representation may occur at any low resolution IRAP pictures since the size of low-resolution IRAP picture is much smaller than the size of high-resolution IRAP picture. When performing ARC, the low-resolution IRAP picture may be carried in the bitstream as inter-layer reference picture for the high-resolution picture.

Still referring to FIG. 10, bitstream No. 1 may be the temporal predicted low-resolution coded stream with periodical IRAP picture, bitstream No. 2 may be the temporal predicted high-resolution coded stream with ARC pictures inter-layer predicted from low resolution IRAP picture. The ARC transition bitstream may include the low-resolution reference picture (POC No. 4), the inter-layer predicted ARC picture (POC No. 4) and the following temporal-predicted high-resolution pictures.

In various embodiments, the recommended ARC transition SEI message may be included in the Sub-picture property SEI message, or being used or transmitted separately. The recommended ARC transition SEI message may include POC value for the high-resolution representation, the POC value of the corresponding lower layer reference picture with representation ID such as layer ID or tile group ID, the scaling filter coefficients, and the prediction method (e.g., temporal prediction or inter-layer prediction).

Table 3 provides an exemplary syntax of a recommended ARC transition SEI message. The message identifies the recommended ARC sub-picture with its layer ID, POC value, and sub-picture ID. The message also indicates multiple sub-pictures recommended to switch from. The scaling filter may support customized scaling filter to improve the ARC quality.

TABLE 3
An example of a recommended ARC transition SEI message

| | Descriptor |
|---|---|
| recommended_arc_transition( payloadSize ) { | |
| arc_layer_id | ue(v) |
| arc_poc_lsb | ue(v) |
| arc_subpic_id | ue(v) |
| num_ref_subpic_minus1 | ue(v) |
| for (i = 0; i <= num_recommended_ref_subpic_minus1; i++) { | |
| reference_subpic_id[ i ] | ue(v) |
| scaling_filter( ) | |
| } | |
| } | |

In Table 3, arc_layer_id may specify the identifier of layer where the ARC sub-picture associated with.

In Table 3, arc_poc_Isb may specify the POC LSB value of the ARC sub-picture.

In Table 3, arc_subpic_id may specify the identifier of the ARC sub-picture.

In Table 3, num_ref_subpic_minus1 plus one may specify the number of recommended sub-picture switched from during ARC.

In Table 3, reference_subpic_id[i] may specify the i-th recommended sub-picture switched from during ARC.

In Table 3, scaling_filter may be the structure containing the recommended scaling filter coefficients.

In various embodiments, the SEI message may provide multiple recommended ARC transition points and prioritize these points. A priority indicator may be signaled in an SEI message to indicate the priority of sub-picture carrying out ARC. Higher priority indicates better ARC performance may be achieved on the associated sub-picture.

### ARC Switching Indicator(s)

An indicator may be used to signal in SEI message, PPS or sub-picture related parameter set to indicate the ARC occurrence to the decoder. The indicator may carry parameters such as layer ID and POC number. Since some pictures after ARC switching point will use a scaled picture as reference, the motion compensation error may impair the performance of those coding tools relying on accurate temporal information and reference samples. For example, the bi-directional optical flow (BDOF) needs to derive the delta motion vector for each 4×4 sub-block based on temporal prediction signal using the difference between two temporal predictions from forward and backward prediction and spatial gradients. Both temporal difference and spatial gradients will be changed after spatial scaling of reference pictures after ARC switching point, the derivation results will be changed greatly. The decoder side motion vector refinement (DMVR) derives the delta motion vector for each sub-block (e.g., 16×16) inside the coding unit using two temporal predictions from two reference pictures. The derivation results will be changed if temporal reference pictures are scaled. The decoder side derivation related coding technologies such as BDOF and DMVR shall be disabled at ARC picture and all subsequent pictures that precede the next IRAP picture in decoding order. In various embodiments, those coding technologies may be disabled based on the indicator signaled in ARC related SEI message, or they may be disabled adaptively based on the scaling ratio. If the scaling ratio is close to 1, then they may be enabled; otherwise if the scaling ratio is far from 1, they may be disabled. Disabling those coding tools may further reduce decoder workload and power consumption w/o impacting the coding performance.

Temporal motion vector prediction (TMVP) and sub-block temporal motion vector prediction (SbTMVP) may also be affected due to motion vector scaling, due to resolution change, and the motion vector error can be propagated within one picture due to motion vector prediction. The error of motion vector has a big impact on picture quality due to motion compensation. In various embodiments, the encoder may disable these decoder side derivation related coding technologies, TMVP and SbTMVP when encoding those pictures such as those inter pictures after ARC switching point which may be affected by reference picture scaling and motion vector scaling, so that the picture quality will not affect too much after ARC switching.

In various embodiments, an indication or a flag (e.g., a constraint flag) may be used to indicate whether one or more coding tools (e.g., predetermined coding tools) are to be disabled at an ARC transition point. In an example, a decoder may detect a constraint flag is set in an SPS, and the constraint flag indicates that a constraint of the one or more coding tools applies to an entire Coded Video Sequence (CVS). For example, layer based spatial scalability may allow each high-resolution enhancement picture to be predicted from a low-resolution (e.g., base layer) picture, and a constraint of the one or more coding tools applies to each enhancement layer (e.g., a layer other than a base layer which is the first layer in the bitstream) frame. For a single-layer sequence, the encoder may set a constraint flag on certain or per-determined frame(s) for ARC transition. The decoder may detect the flag at the slice level and carry out ARC on the associated frame (e.g., a frame that contains the slice).

Table 4 provides an exemplary syntax of an SPS including a constraint flag, sps_arc_constraint_flag, which is signaled in the SPS.

TABLE 4
An example of an SPS syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| .... | ue(v) |
| sps_arc_constraint_flag | u(1) |
| timing_info_present_flag | u(1) |
| .... | |
| rbsp_trailing_bits( ) | |
| } | |

In Table 4, sps_arc_constraint_flag is a constraint flag. When the value of sps_arc_constraint_flag equals 1, it indicates or specifies that coding tools TMVP, DMVR, and/or BDOF shall be disabled (e.g., slice_temporal_mvp_enabled_flag, bdofFlag, and/or dmvrFlag having a value that equals 0) for the CVS associated with the SPS. When sps_arc_constraint_flag has a value that equals 0, the flag indicates or specifies that it does not impose a constraint.

Table 5 provides an exemplary syntax of a slice header. A constraint flag, slice_arc_constraint_flag, is signaled in the slice header.

TABLE 5
An example of an slice header syntax

| | Descriptor |
|---|---|
| slice_header( ) { | |
| slice_pic_parameter_set_id | ue(v) |
| if( rect_slice_flag ∥ NumBricksInPic > 1 ) | |
| slice_address | u(v) |
| if( !rect_slice_flag && !single_brick_per_slice_flag ) | |
| num_bricks_in_slice_minus1 | ue(v) |
| slice_type | ue(v) |
| if( NalUnitType = = GRA_NUT ) | |
| recovery_poc_cnt | se(v) |
| slice_pic_order_cnt_lsb | u(v) |
| if ( !sps_arc_constraint_flag ) | |
| slice_arc_constraint_flag | u(1) |
| ... | |
| if ( slice_type != I ) { | |
| if( sps_temporal_mvp_enabled_flag && | |
| !slice_arc_constraint_flag ) | |
| slice_temporal_mvp_enabled_flag | u(1) |
| ... | |

In Table 5, slice_arc_constraint_flag is a constraint flag. When the value of slice_arc_constraint_flag equals 1, it indicates or specifies that coding tools TMVP, DMVR, and/or BDOF shall be disabled (e.g., slice_temporal_mvp_enabled_flag, bdofFlag, and/or dmvrFlag of the associated slice having a value that equals 0) for the associated slice. When slice_arc_constraint_flag has a value that equals 0, the flag indicates or specifies that it does not impose a constraint. When slice_arc_constraint_flag is not present, it is inferred to have a value that equals 1.

In various embodiments, the constraint of coding tools (e.g., as signaled using one or more constraint flags described above) may indicate (or provide a reference of) a known or fixed set of tools to be disabled after an ARC transition. For example, the constraint of coding tools may disable BDOF and DMVR after an ARC transition and/or until the next IRAP picture. In another embodiment, additional signaling (e.g., one or more additional flags) may be provided in the syntax to adaptively specify which coding tools are to be disabled when the constraint of coding tools is active. For example, a first flag may specify whether BDOF is to be disabled by the constraint of coding tools, a second flag may specify whether DMVR is to be disabled by the constraint of coding tools, and one or more additional flags may specify whether other tools are to be disabled by the constraint of coding tools.

In various embodiments, Table 6 provides an exemplary syntax of an VPS, where an all-layer independent flag is used to indicate that each layer is independently coded, so that the dependency among layers does not need to be specified.

TABLE 6
An example of an VPS syntax

| | Descriptor |
|---|---|
| video_parameter_set_rbsp( ) { | |
| vps_video_parameter_set_id | u(4) |
| vps_max_layers_minus1 | u(8) |
| for( i = 0; i <= vps_max_layers_minus1; i++ ) { | |
| vps_included_layer_id[ i ] | u(7) |
| vps_reserved_zero_bit | u(1) |
| } | |
| vps_all_layers_independent_flag | u(1) |
| for( i = 1; i <= MaxLayersMinus1; i++ ) { | |
| layer_id_in_nuh[ i ] | u(6) |
| if (!vps_all_layers_independent_flag) | |
| for( j = 0; j < i; j++ ) | |
| direct_dependency_flag[ i ][ j ] | u(1) |
| } | |
| ... | |
| } | |

In Table 6, vps_all_layers_independent_flag equal to 1 may specify that each layer (specified by the VPS) is an independent layer, and vps_all_layers_independent_flag equal to 0 may specify that one or more layers (specified by the VPS) may not be independent layer(s). When vps_all_layers_independent_flag is set to 1, layer dependency signaling (e.g., a direct_dependency_flag) is not necessary to be signaled.

In various embodiments, methods and apparatus for picture and/or video coding in communication systems are provided. For example, a method may comprise selectively including in an SEI message sub-picture property information for use with adaptive switching of a viewport, and generating/transmitting the SEI message. The method may also comprise identifying a set of sub-pictures associated with the viewport, and identifying the sub-picture property information associated with the identified set of sub-pictures. In an example, selectively including the sub-picture property information in the SEI message may comprise generating the SEI message comprising the identified sub-picture property information.

In various embodiments, the sub-picture property information indicates and/or includes any of: one or more layer identifications (IDs), one or more tile group IDs, the coordinate of each sub-picture, a position and a format of each sub-picture of the set of sub-pictures, mapping information for each sub-picture to be mapped onto a sphere coordinate space of the picture, a bit depth, color sub-sampling information, an encoding profile, and an encoding level for one or more sub-pictures.

In various embodiments, the method may comprise generating a syntax to indicate the sub-picture property information in the SEI message.

In various embodiments, a set of sub-pictures may be a set of tile groups associated with the picture.

In various embodiments, a method may comprise selectively including in an SEI message sub-picture property information for use with ARC in connection with adaptive switching of a viewport, and generating/transmitting the SEI message. In an example, the sub-picture property information may comprise information that indicates any of a low-resolution sub-picture and a high-resolution sub-picture to which ARC may be applied for adaptive switching of the viewport. In an example, the low-resolution sub-picture and the high-resolution sub-picture are associated with the same source content region used for the viewport.

In various embodiments, the SEI message may be transmitted after a frame that includes a first IRAP picture and prior to a next frame that includes a second IRAP picture.

In various embodiments, any of the methods discussed herein may include identifying a set of sub-pictures associated with a picture available for ARC, and the set of sub-pictures includes the low-resolution sub-picture and the high-resolution sub-picture, and identifying the sub-picture property information associated with the identified set of sub-pictures. In an example, selectively including the sub-picture property information in the SEI message may comprise generating the SEI message comprising the identified sub-picture property information.

In various embodiments, a method may comprise receiving an SEI message including sub-picture property information for use with adaptive switching of a viewport, and performing ARC based on the sub-picture property information.

In various embodiments, the sub-picture property information may include information that indicates any of a low-resolution sub-picture and a high-resolution sub-picture to which the ARC may be applied for adaptive switching of the viewport.

In various embodiments, ARC may be carried out, at least in part, by adapting the indicated low-resolution sub-picture to a high-resolution sub-picture, and/or adapting the indicated high-resolution sub-picture to a low-resolution sub-picture.

In various embodiments, performing ARC may comprise performing the ARC in connection with adaptive switching of the viewport based on the sub-picture property information.

In various embodiments, ARC may be carried out without introducing an IRAP picture frame.

In various embodiments, ARC may be carried out, at least in part, by adapting the indicated low-resolution sub-picture to a high-resolution sub-picture, and adapting the indicated high-resolution sub-picture to a low-resolution sub-picture.

In various embodiments, any of the methods discussed herein may include decoding a received SEI message.

In various embodiments, performing ARC may comprise scaling up the low-resolution sub-picture based on the sub-picture property information.

In various embodiments, performing ARC may comprise scaling down the high-resolution sub-picture based on the sub-picture property information.

In various embodiments, performing ARC may comprise aligning coordinates between a set of sub-pictures and a set of corresponding reference sub-pictures based on the sub-picture property information.

In various embodiments, performing ARC may comprise determining a position and a format of a sub-picture based on the sub-picture property information, determining a resolution of a corresponding reference sub-picture, scaling a resolution of the sub-picture based on the determined position and format, and the resolution of the reference sub-picture, and mapping the scaled sub-picture to a corresponding coordinate of the picture.

In various embodiments, a sub-picture may include a tile group.

In various embodiments, any of the methods discussed herein may include determining whether the corresponding reference sub-picture collocates with the sub-picture based on the sub-picture property information.

In various embodiments, an SEI message may include a syntax having the sub-picture property information.

In various embodiments, a syntax may be carried by a cross-layer parameter set.

In various embodiments, sub-picture property information may indicate the coordinate(s) of each repositioned sub-picture relative to a conformance cropping window.

In various embodiments, any of the methods discussed herein may include determining a corresponding reference sub-picture available in one or more previous pictures, and deriving a position and a format of the corresponding reference sub-picture based on the sub-picture property information.

In various embodiments, sub-picture property information may indicate properties of a set of sub-pictures including one or more low-resolution sub-pictures and one or more high-resolution sub-pictures.

In various embodiments, a method may comprise identifying an ARC switching point where one or more pictures after the ARC switching point use a scaled picture as a reference, and sending an indicator indicating the ARC switching point.

In various embodiments, the indicator is transmitted in any of: an SEI message, a Picture Parameter Set (PPS), and a sub-picture related parameter set.

In various embodiments, the indicator includes parameters, wherein the parameters include any of: a layer ID, and a picture order count (POC) value.

In various embodiments, a method may comprise receiving an indicator indicating an ARC switching point, and identifying the ARC switching point and a scaled picture. In various embodiments, one or more pictures received after the ARC switching point may use the scaled picture as a reference.

In various embodiments, a method may comprise identifying a set of sub-pictures associated with a picture being available or recommended to perform ARC, and generating/sending an SEI message indicating one or more parameters of the set of sub-pictures.

In various embodiments, one or more parameters discussed above may include any of: a POC value for a high-resolution representation of the picture, a POC value of a corresponding lower-layer reference picture with a representation ID, one or more scaling filter coefficients, and a prediction method.

In various embodiments, a representation ID may be a layer ID or a tile group ID.

In various embodiments, a prediction method may include any of: a temporal prediction and an inter-layer prediction.

In various embodiments, a syntax may indicate information of a sub-picture of the set of sub-pictures, wherein the information includes any of: a layer ID, a POC value, and a sub-picture ID associated with the sub-picture.

In various embodiments, a method may comprise receiving an SEI message associated with a picture, and identifying a set of sub-pictures recommended to perform an ARC based on one or more parameters indicated in the SEI message, and selecting one or more sub-pictures from the set of sub-pictures to perform the ARC.

In various embodiments, an SEI message may include a priority indicator indicating a priority of a respective sub-picture of the set of sub-pictures.

In various embodiments, a priority discussed herein may be a high priority that indicates a better ARC performance on the respective sub-picture.

In various embodiments, an apparatus may comprise one or more processors, encoders, decoders, transmitters, receivers, and/or memory implementing or performing any method discussed herein.

In various embodiments, a middle box may comprise one or more processors, encoders, decoders, transmitters, receivers, and/or memory implementing or performing any method discussed herein.

Each of the following references are incorporated by reference herein: [1] JCTVC-F158, “Resolution switching for coding efficiency and resilience”, July 2011; [2] JVET-M0135, “On adaptive resolution change for VVC”, January 2019; [3] JVET-M0259, “Use cases and proposed design choices or adaptive resolution changing”, January 2019; [4] JVET-M0261, “AHG12: On grouping of tiles”, January 2019; and [5] U.S. Provisional Patent Application No. 62/775,130.

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”) or non-volatile (e.g., Read-Only Memory (“ROM”) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of (or interchangeable with) any UE or mobile device recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-21. (canceled)

22. A method comprising:
selectively including in a supplemental enhancement information (SEI) message sub-picture property information for use with adaptive switching of a viewport; and
including the SEI message in a bitstream.

23. The method of claim 22, further comprising:
identifying a set of sub-pictures associated with the viewport; and
identifying the sub-picture property information associated with the identified set of sub-pictures, wherein selectively including the sub-picture property information in the SEI message comprises:
generating the SEI message comprising the identified sub-picture property information.

24. The method of claim 22, wherein the sub-picture property information indicates or comprises any of: one or more layer identifications (IDs), one or more tile group IDs, a coordinate of each sub-picture, a position and a format of each sub-picture of a set of sub-pictures, mapping information for each sub-picture to be mapped onto a sphere coordinate space of the picture, a bit depth, color sub-sampling information, an encoding profile, or an encoding level for one or more sub-pictures.

25. The method of claim 22, wherein selectively including the sub-picture property information in the SEI message comprises:
generating a syntax to indicate the sub-picture property information in the SEI message.

26. The method of claim 23, wherein the set of sub-pictures is a set of tile groups associated with the picture.

27. A method comprising:
receiving a supplemental enhancement information (SEI) message associated with a picture;
identifying a set of sub-pictures recommended to perform an Adaptive Resolution Change (ARC) based on one or more parameters indicated in the SEI message; and
selecting one or more sub-pictures from the set of sub-pictures to perform the ARC.

28. The method of claim 27, wherein the one or more parameters include any of:
a picture order count (POC) value for a high-resolution representation of the picture,
a POC value of a corresponding lower-resolution reference picture with a representation ID,
one or more scaling filter coefficients, or
a prediction method.

29. The method of claim 28, wherein the representation ID is a layer ID or a tile group ID.

30. The method of claim 28, wherein the prediction method includes any of: a temporal prediction and an inter-layer prediction.

31. The method of claim 27, wherein the SEI message includes a syntax.

32. The method of claim 31, wherein the syntax indicates information of a sub-picture of the set of sub-pictures, wherein the information includes any of: a layer ID, a POC value, and a sub-picture ID associated with the sub-picture.

33. The method of claim 27, wherein the SEI message includes a priority indicator indicating a priority of a respective sub-picture of the set of sub-pictures.

34. The method of claim 33, wherein the priority is a high priority that indicates a better ARC performance on the respective sub-picture.

35. An apparatus comprising one or more processors configured to:
selectively include in a supplemental enhancement information (SEI) message sub-picture property information for use with adaptive switching of a viewport; and
include the SEI message in a bitstream.

36. The apparatus of claim 35, wherein the one or more processors are further configured to:
identify a set of sub-pictures associated with the viewport, and
identify the sub-picture property information associated with the identified set of sub-pictures, wherein selectively including the sub-picture property information in the SEI message comprises:
generate the SEI message comprising the identified sub-picture property information.

37. The apparatus of claim 35, wherein the sub-picture property information indicates or comprises any of: one or more layer identifications (IDs), one or more tile group IDs, a coordinate of each sub-picture, a position and a format of each sub-picture of a set of sub-pictures, mapping information for each sub-picture to be mapped onto a sphere coordinate space of the picture, a bit depth, color sub-sampling information, an encoding profile, or an encoding level for one or more sub-pictures.

38. The apparatus of claim 35, wherein the one or more processors are further configured to generate a syntax to indicate the sub-picture property information in the SEI message.

39. The apparatus of claim 36, wherein the set of sub-pictures is a set of tile groups associated with the picture.

40. An apparatus comprising one or more processors configured to:
receive a supplemental enhancement information (SEI) message associated with a picture;
identify a set of sub-pictures recommended to perform an adaptive resolution change (ARC) based on one or more parameters indicated in the SEI message; and
select one or more sub-pictures from the set of sub-pictures to perform the ARC.

41. The apparatus of claim 40, wherein the one or more parameters include any of:
a picture order count (POC) value for a high-resolution representation of the picture,
a POC value of a corresponding lower-resolution reference picture with a representation ID,
one or more scaling filter coefficients, or
a prediction method.
